(19) United States
(12) Patent Application Publication
(10) Pub. No.: US 2020/0409650 A1
(43) Pub. Date: Dec. 31, 2020

(54) AUDIO PLAYING METHOD, COMPUTER APPARATUS AND STORAGE MEDIUM

(71) Applicant: Shanghai Edaysoft Co., Ltd., Shanghai (CN)

(72) Inventor: Hong Jiang, Shanghai (CN)

(73) Assignee: Shanghai Edaysoft Co., Ltd., Shanghai (CN)

(21) Appl. No.: 16/657,241

(22) Filed: Oct. 18, 2019

(30) Foreign Application Priority Data
Jun. 28, 2019 (CN) 201910577997.X

(51) Int. Cl. G06F 3/16; G06F 16/68; H04L 9/06

(52) U.S. Cl. CPC G06F 3/165; G10H 2210/076; H04L 9/0618; G06F 16/686

(57) ABSTRACT

The present disclosure relates to an audio playing method, computer apparatus and storage medium. The method includes: obtaining an original audio and a label file corresponding to the original audio, the label file comprising an audio effect audio and an audio effect interval, the audio effect audio comprising an audio effect to be added into the original audio; playing the original audio, and traversing the label file according to a playing progress of the original audio; and playing the audio effect audio in response to that the original audio is played to the audio effect interval.

### TECHNICAL FIELD

The present disclosure relates to computer technical fields, and more particularly to an audio playing method, computer apparatus and storage medium.

### BACKGROUND

With the development of computer technology and network information, people have begun to transmit and publish information via networks. The Internet has become an important part of people's entertainment and work, while digital audios have become a popular form of network data. With the development of the big data era, applications of audio data will also become increasingly wider.

### SUMMARY

According to various embodiments of the present disclosure, an audio playing method, computer apparatus and storage medium are provided, which can facilitate the synthesized audio to be edited and modified.

An audio playing method includes: obtaining an original audio and a label file corresponding to the original audio, the label file comprising an audio effect audio and an audio effect interval, the audio effect audio comprising an audio effect to be added into the original audio; playing the original audio, and traversing the label file according to a playing progress of the original audio; and playing the audio effect audio in response to that the original audio is played to the audio effect interval.

A computer apparatus includes one or more processors, and a memory storing computer-readable program, which, when executed by the one or more processors cause the one or more processors to perform the above mentioned method.

At least one non-transitory computer-readable storage medium includes computer-readable instructions, which, when executed by one or more processors, cause the one or more processors to perform the above mentioned method.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

To illustrate the technical solutions of the embodiments or the prior art more clearly, the accompanying drawings for describing the embodiments or the prior art are introduced briefly in the following. Apparently, the accompanying drawings in the following description are only some embodiments of the present invention, and persons of ordinary skill in the art can derive accompany drawings of other embodiments from these accompanying drawings without creative efforts.

FIG. 1 is a schematic diagram illustrating an environment adapted for an application scenario illustration of an audio playing method according to an embodiment.

FIG. 2 is a flowchart of a method of playing the audio according to an embodiment.

FIG. 3 is a flowchart of a method for generating a label file according to an embodiment.

FIG. 4 is a flowchart of step S304 according to an embodiment;

FIG. 5 is a block diagram of an audio playing device according to an embodiment.

FIG. 6 is a block diagram of a computer apparatus according to an embodiment.

### DETAILED DESCRIPTION OF THE EMBODIMENTS

In order to make the objects, technical solutions and advantages of the present disclosure more comprehensible, the present disclosure will be described in detail below with reference to the accompanying drawings and embodiments. It should be understood that the detailed embodiments described herein are merely to explain the present disclosure, but not intended to limit the same.

Conventionally, when it is desired to add one or more audio effects into an original audio so as to achieve the effects of adding the audio effect into the original audio, it is common to splice or synthesis several to-be-synthesized audios together and in turn play the synthesized audio. However, in the above conventional method, when it is desired to modify or reedit the synthesized audio, the editing and modifying are difficult, since the several original audios at the beginning must be reedited and modified.

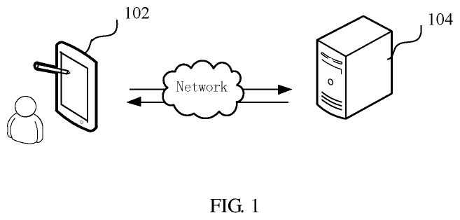

The present disclosure provides an audio playing method. The method may be implemented in an application environment as shown in FIG. 1. A terminal 102 communicates with a server 104 via networks. An environment for implementing the audio playing method is provided for the terminal 102 by the server 104. The terminal 102 is integrated in this environment to add an audio effect in an original audio according to a label file corresponding to the original audio via the environment when playing the original audio, so as to implement a playing effect by synthesizing the audio effect and the original audio. The terminal 102 may include, but not limited to, computer, laptop, smart phone, tablet, and portable wearable device. The server 104 may be implemented with a separate server or a server farm comprised of a plurality of servers.

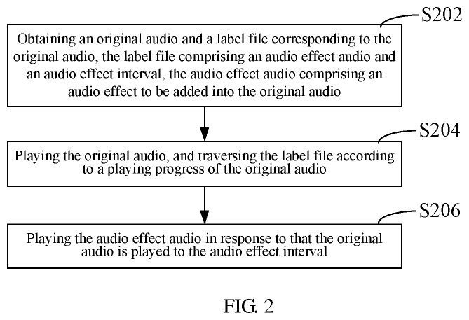

In an embodiment, the audio playing method is provided, as shown in FIG. 2. To illustrate by way of example having the terminal implemented in this method in FIG. 1, the method includes the following steps.

At step S202, an original audio and a label file corresponding to the original audio are obtained. The label file includes an audio effect audio and an audio effect interval. The audio effect audio includes an audio effect to be added in the original audio.

The original audio is an audio file obtained by the terminal 102 from the server 104, and may be in any common audio format, such as mp3, WMA, WAV, and the like.

The audio effect audio is an audio file containing the content of the audio effect to be added into the original audio. The audio effect may include a piece of music, a gunshot, a tweet, and the like, which may be configured by the server according to the practical need for adding. The audio effect audio may be in any common audio format, such as mp3, WMA, WAV and the like.

The label file is a file configured to label the position, in which the audio effect is added in the original audio, and the added audio effect audio. In the label file, the position (i.e. the audio effect interval), in which the audio effect is added in the original audio, may be represented by a time of playing the original audio. For example, a certain audio effect in the audio effect audio is added when the first minute to the one minute three second of the original audio is played.

Specifically, the original audio is first analyzed by the server to create the label file labeling the position, in which the audio effect is added in the original audio, and the added audio effect. The original audio and the corresponding label file may be obtained by the terminal from the server for parsing and playing. That is, a program parsing the label file is provided by the server to the terminal, such that the terminal can identify the label file created by the server.

At step S204, the original audio is played, and the label file is traversed according to a playing progress of the original audio.

Specifically, after the original audio and the label file are obtained by the terminal at step S202, if the terminal receives an instruction to play the original audio from the user, the label file is traversed while playing the original audio. When to play the corresponding audio effect is determined according to the audio effect interval labeled in the label file, and which type of audio effect will be added is determined according to the added audio effect labeled in the label file.

At step S206, the audio effect audio is played in response to that the original audio is played to the audio effect interval of the label file.

Specifically, when it is detected that the original audio is played to the corresponding audio effect interval in the label file, the audio effect audio corresponding to this audio effect interval is played, such that the user will feel the effect that the audio effect is added into the original audio.

Optionally, the server may restrict the terminal's access to the label file according to the identity of the terminal, and may set the attribute of the label file, such as hidden, read-only, and read-write operations.

According to the audio playing method, the terminal obtains the original audio, in which the audio effect is to be added, and the label file indicating the audio effect added in the original audio and the audio effect interval in which the audio effect should be added in the original audio. While this original audio is played by the terminal, the label file is traversed. When the original audio is played to the audio effect interval, the corresponding audio effect audio will be played simultaneously, such that the user can feel the effect of adding the audio effect into the original audio. When it is desired to adjust the content and the position of the audio effect added in the original audio, it is required to only modify the label file, so as to facilitate the synthesized audio to be edited and modified.

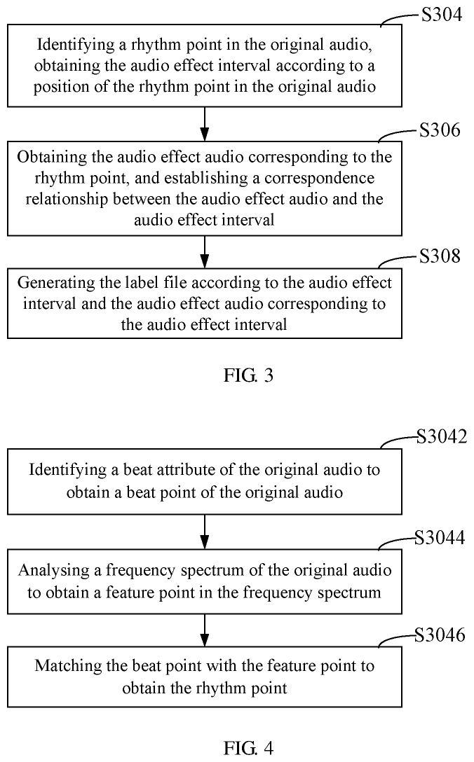

In an embodiment, referring to FIG. 3, the label file in step S202 is obtained specifically by the following steps.

At step S304, a rhythm point in the original audio is identified, and the audio effect interval is obtained according to a position of the rhythm point in the original audio.

Specifically, the original audio for creating the label file is first obtained by the server. The skilled person may select different kinds of audios downloaded from the Internet, for example, popular songs or classical piano music, and the like, which are regarded as the original audio in which the audio effect is synthesized.

The audio effect interval in which the audio effect is added in the original audio may be set according to the rhythm point of the original audio. In order to ensure the effect after adding the audio effect in the original audio, the audio effect is usually added to the rhythm point.

The rhythm point is a point obtained by identifying the rhythm of the original audio by the server and configured to characterize the rhythm of the corresponding original audio. The server may identify the position of the rhythm point in the music file according to a preset rhythm identifying algorithm. The rhythm identifying algorithm may include: obtaining a frequency spectrum corresponding to the original audio when playing the original audio, and capturing a repeated frequency band in the frequency spectrum. Alternatively, the rhythm point may also be identified according to the strength, level and other factors of the sound when playing the original audio.

The audio effect interval is an area, in which the audio effect is to be added, obtained according to the identified rhythm point. The audio effect interval may coincide with the rhythm point, that is, the audio effect is added exactly at the rhythm point of the original audio. The audio effect interval may also be adjusted according to the practical playing effect of the added audio effect. For example, the audio effect interval may be configured as a time interval, starting from the rhythm point on, and lasting for several seconds, or the like. After all of the audio effect intervals, in which the audio effects are to be added in the original audio, are obtained by the server, time intervals of the playback of the original audio may be used to represent these audio effect intervals. For example, the area of the original audio from the 1 minute to the 1 minute 2 second can be regarded as an audio effect interval, and the time interval of the original audio from the 1 minute 30 second to the 1 minute 33 second can be regarded as another audio effect interval. Optionally, the time length of the audio effect interval may also be adjusted according to the lasting time of the to-be-added audio effect or the type of the rhythm point. As for a gunshot audio effect lasting for 1S, the audio effect interval may be configured as a time interval containing the rhythm point and lasting for 1S.

At step S306, the audio effect audio corresponding to the rhythm point is obtained, and a correspondence relationship between the audio effect audio and the audio effect interval is established.

The to-be-added audio effect may be edited by the server. The created audio effect audio is stored in a preset position. When an audio effect corresponding to a certain audio effect interval in the original audio is to be obtained by the server, the corresponding audio effect audio is obtained from a preset position according to the factors such as the lasting time of the audio effect interval or the type of the rhythm point corresponding to the audio effect interval, or the like. By way of creating a label corresponding to the audio effect audio on the audio effect interval or the like, the correspondence relationship between the audio effect audio and audio effect interval is established.

At step S308, the label file is created according to the audio effect interval and the audio effect audio corresponding to the audio effect interval.

Specifically, according to the relationship between all of the audio effect intervals identified in the original audio and the audio effect audios corresponding to the audio effects, which need to be added when playing the audio effect interval, the label file that may be identified by a terminal is created by the server. The label file may be stored in a format as a mid file or an xml file. The step of creating the label file is the step of creating the corresponding mid file or xml file according to the original audio.

In the above embodiment, the server 104 set first the audio effect interval according to the rhythm point of the original audio, and set a mapping relationship between each audio effect interval and the added audio effect audio, such that the terminal which obtains the label file can implement the audio playing method in which the audio effect is added to the original audio according to the label file.

In an embodiment, in the above audio playing method, the obtaining the audio effect audio corresponding to the rhythm point, and establishing the correspondence relationship between the audio effect audio and the audio effect interval at step S306, may include: obtaining a label of the audio effect audio corresponding to the rhythm point, labeling the label of the audio effect audio on the audio effect interval. The playing the audio effect audio in response to that the original audio is played to the audio effect interval of the label file at step S206, may include: obtaining the audio effect audio corresponding to the label of the audio effect audio labeled on the audio effect interval in response to that the original audio is played to the audio effect interval, and playing the audio effect audio.

The label of the audio effect audio is a link type symbol for obtaining the audio effect audio. The corresponding audio effect audio may be acquired via the label by the server from a preset address. The label of the audio effect audio may be represented by means of abbreviation, encoding or the like.

Specifically, after the audio effect audio corresponding to the audio effect interval is obtained by the server from the preset address storing the audio effect audio according to the factors, such as time length and rhythm point attribute of the audio effect interval and the like, the audio effect audio is represented in the label file with the label of the audio effect audio. After the original audio and the label file corresponding to the original audio are obtained by the terminal, the corresponding audio effect audio may also be obtained through the label of the audio effect audio, and when playing the original audio, timing for playing the obtained audio effect audio is determined according to the audio effect interval in the label file.

Optionally, the label file may also include a non-audio-effect interval in addition to the audio effect interval, and represent the non-audio-effect interval according to a time interval when the original audio is played. For example, a label file of an original audio may be represented as “empty[H], c1[k1], empty[HIJK], c2[k2], empty[HJK], c1[k1]”, wherein c1, c2 are labels of audio effect audios, which represent the audio effect audio files stored in the preset addresses. Empty represents a non-audio-effect interval, while content in a square bracket behind an empty represents a time interval of the non-audio-effect interval. The contents in the square brackets behind c1, c2 represent time intervals of the audio effect intervals.

In the above embodiment, by using the label corresponding to the audio effect audio as a method for identifying the audio effect audio without inserting the source file of the audio effect audio into the label file, the data volume of the label file is enormously reduced, which facilitates the data transmission of the label file between the server and the terminal. Moreover, when modifying the audio effect audio in the label file, it is required only to alter the label of the audio effect audio.

In an embodiment, referring to FIG. 4, the identifying the rhythm point in the original audio at step S304 of the above described audio playing method, may include the following steps accordingly.

At step S3042, a beat attribute of the original audio is identified to obtain a beat point of the original audio.

Specifically, the beat attribute is referred to a BPM (labeling the Beats Per Minute of music) attribute of the original audio. The identification of the BPM of the original audio may be performed by the server via common music analysing software, such as metronome, BPM test tool (MixMeister BPM Analyzer) and the like, to obtain the beat attribute of the original audio, and to identify the beat point in the original audio characterizing the beat attribute. Furthermore, the original audio of the song class often includes a main song, a chorus, an interlude, etc. In order to identify the rhythm attribute and to label the rhythm point of such original audio more accurately, the original song audio can be segmented according to the main song, the chorus, and the interlude. Then, the audio section segmented can be identified by the BPM. At last, all of the segments of the BPM are fused, and the beat points of the original audio of the song class are finally obtained.

At step S3044, a frequency spectrum of the original audio is analyzed to obtain a feature point in the frequency spectrum of the original audio.

Specifically, the server parses the frequency spectrum of the original audio according to the frequency spectrum analysis, which may be specifically implemented via the analysis method such as FFT (Fast Fourier Transformation) frequency spectrum analysis or by using the frequency spectrum analysis tool such as Cubase or the like. Further, the feature point in the frequency spectrum may be obtained by setting a feature point obtaining algorithm. For example, a point, in the frequency spectrum, having a db (decibel) higher than a preset value obtained according to experience and experiment adjustments, may be regarded as a feature point.

At step S3046, the beat point of the original audio is matched with the feature point to obtain the rhythm point.

Specifically, the terminal matches the beat point obtained at step S3042 with the feature point obtained at step S3044 to obtain the rhythm point of the original audio. Optionally, a point, where the beat point and the feature point coincide, may be regarded as the rhythm point.

In the above embodiment, the rhythm point of the original audio is eventually determined by the double-analysis on the beat attribute and frequency spectrum of the original audio, so as to obtain the rhythm point more precisely.

In an embodiment, after creating the label file at step S308, the method may further include: obtaining a preset encryption algorithm, encrypting the label file via the preset encryption algorithm; thus, after obtaining the original audio and the label file corresponding to the original audio at step S202, the method further includes: decrypting the encrypted label file according to a decryption algorithm corresponding to the preset encryption algorithm.

Specifically, the preset encryption algorithm, which may use Base 64 encryption method or the like, is an algorithm encrypting the label file. Furthermore, when the terminal or other apparatuses need to parse the label file, it is required to decrypt the encrypted label file according to the preset encryption algorithm. Only when the label file is decrypted first, the corresponding operations on the label file may be performed.

In the above described processes of encrypting the label file, and sharing and transmitting the original audio and the label file in turn, the security of the critical information reflected by the label file of the method for labeling the rhythm point of the original audio and adding the audio effect may be ensured.

In an embodiment, after creating the label file at step S308, the method may further include: playing the original audio and traversing the label file according to the playing progress of the original audio; if a modification instruction to the label file is received, modifying the label file according to the modification instruction.

When the original audio is played according to the label file after the label file is created by the server, if the playing effect of the original audio in which the audio effect is added, is not satisfying, the modification instruction is sent to the server. The modification instruction may be an instruction adjusting the audio effect interval in the label file, or may be an instruction to replace or retract the audio effect audio.

In the above described embodiment, after creating the label file by the server and prior to publishing the label file to the terminal for downloading, the playing effect of the original audio needs to be verified. By the modification instruction, the position, the audio effect content, or the like, may be modified, so that the playing effect becomes more complied with practical requirements.

It should be understood that although all of the steps in the flowcharts of FIG. 2 to FIG. 4 are shown sequentially as the indication of the arrows, these steps do not have to be performed in such sequence as indicated by the arrows. Performing these steps does not have any sequential limitation such that these steps may be performed in another sequence, unless it is illustrated explicitly in the context. Moreover, at least a part of steps of FIG. 2 to FIG. 4 may include multiple sub-steps or multiple phases which may be performed at different times other than have to be accomplished at the same time, which may be performed in turn or alternately with the other steps or at least a part of the sub-steps or phases of the other steps, other than have to be performed sequentially.

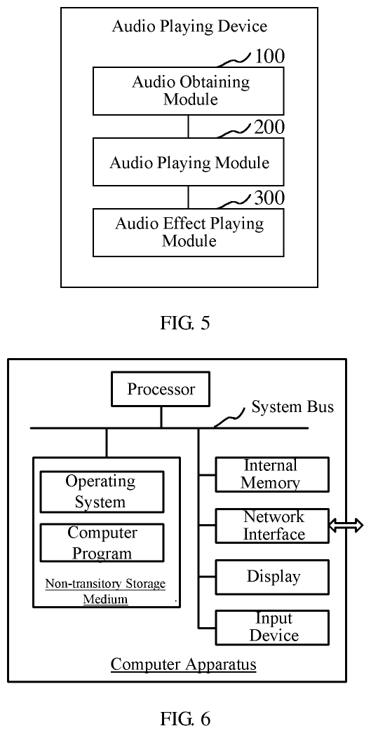

In an embodiment, referring to FIG. 5, an audio playing device is provided, including an audio obtaining module 100, an audio playing module 200 and an audio effect playing module 300.

The audio obtaining module 100 is configured to obtain an original audio and a label file corresponding to the original audio. The label file includes an audio effect audio and an audio effect interval. The audio effect audio includes an audio effect to be added in the original audio.

The audio playing module 200 is configured to play the original audio, and traverse the label file according to a playing progress of the original audio.

The audio effect playing module 300 is configured to play the audio effect audio in response to that the original audio is played to the audio effect interval of the label file.

In an embodiment, the above audio playing device may further include:

an original audio obtaining module configured to obtain the original audio;

an audio effect interval obtaining module configured to identify a rhythm point in the original audio, obtaining the audio effect interval according to a position of the rhythm point in the original audio;

an audio effect associating module configured to obtain the audio effect audio corresponding to the rhythm point, and establish the correspondence relationship between the audio effect audio and the audio effect interval;

a label file generating module configured to create the label file according to the audio effect interval and the audio effect audio corresponding to the audio effect interval.

In an embodiment, the audio effect associating module in the audio playing device may further be configured to obtain a label of the audio effect audio corresponding to the rhythm point, and label the label of the audio effect audio on the audio effect interval.

The audio effect playing module 300 may further be configured to obtain the audio effect audio corresponding to the label of the audio effect audio labeled on the audio effect interval in response to that the original audio is played to the audio effect interval, and play the audio effect audio.

In an embodiment, the audio effect interval obtaining module in the audio playing device may include:

a beat identifying unit configured to identify a beat attribute of the original audio to obtain a beat point of the original audio;

a frequency spectrum analysing unit configured to analyze a frequency spectrum of the original audio to obtain a feature point in the frequency spectrum of the original audio;

a rhythm point obtaining unit configured to match the beat point of the original audio with the feature point to obtain the rhythm point of the original audio.

In an embodiment, the above audio playing device may further include:

an encryption module configured to obtain a preset encryption algorithm, and encrypt the label file according to the preset encryption algorithm;

a decryption module configured to decrypt the encrypted label file according to a decryption algorithm corresponding to the preset encryption algorithm.

In an embodiment, the above audio playing device may further include:

a detection module configured to play the original audio, and traverse the label file according to the playing progress of the original audio;

a modification instruction configured to, if a modification instruction to the label file is received, modify the label file according to the modification instruction.

The specific definitions of the audio playing device may refer to the above definitions of the audio playing method, and details will not be described herein thereto. Each module in the above audio playing device may be implemented in whole or in part by software, hardware and a combination thereof. Each of the above modules may be in a hardware form embedded in or independent of a processor in a computer apparatus, or may be in a software form stored in a memory in the computer apparatus, in order to be called by the processor to execute the operations corresponding to each of the above modules.

In an embodiment, a computer apparatus is provided. The computer apparatus may be a terminal. The internal structure diagram thereof may be as shown in FIG. 6. The computer apparatus includes a processor, a memory, a network interface, a display and an input apparatus, connected via a system bus. The processor of the computer apparatus is configured to provide computing and control capabilities. The memory of the computer apparatus includes a non-transitory storage medium and an internal memory. The non-transitory storage medium stores an operating system and a computer program. The internal memory provides an environment for the operation of the operating system and computer programs in the non-transitory storage medium. The network interface of the computer apparatus is configured to communicatively connected to an external terminal via networks. The computer program is executed by the processor to implement an audio playing method. The display of the computer apparatus may be a liquid crystal display or an electronic ink display. The input apparatus of the computer apparatus may be a touch layer covering the display, or may be a button, a trackball or a touch pad arranged on the housing of the computer apparatus, or also may be a keyboard, a touch pad, a mouse and the like connected externally.

It will be understood by those skilled in the art that the structure shown in FIG. 6 is only a block diagram of a part of the structure related to the solution of the present disclosure, and does not constitute any limitation to the computer device to which the solution of the present disclosure is applied. The specific computer device may include more or fewer parts than shown in the figures, or arrangements combining some parts or having different part.

In an embodiment, a computer apparatus is provided. The computer apparatus includes a memory storing a computer program and a processor. The computer program, when executed by the processor, implements the following steps: obtaining an original audio and a label file corresponding to the original audio, the label file including an audio effect audio and an audio effect interval, the audio effect audio including an audio effect to be added in the original audio; playing the original audio, and traversing the label file according to a playing progress of the original audio; and playing the audio effect audio in response to that the original audio is played to the audio effect interval of the label file.

In an embodiment, the method for creating the label file that is implemented when the computer program is executed by the processor, includes: obtaining the original audio; identifying a rhythm point in the original audio, and obtaining an audio effect interval according to a position of the rhythm point in the original audio; obtaining an audio effect audio corresponding to the rhythm point, and establishing a correspondence relationship between the audio effect audio and the audio effect interval; creating the label file according to the audio effect interval and the audio effect audio corresponding to the audio effect interval.

In an embodiment, the obtaining the audio effect audio corresponding to the rhythm point, and establishing the correspondence relationship between the audio effect audio and the audio effect interval which is implemented when the computer program is executed by the processor, includes: obtaining a label of the audio effect audio corresponding to the rhythm point, labeling the label of the audio effect audio on the audio effect interval; and the playing the audio effect audio in response to that the original audio is played to the audio effect interval of the label file which is implemented when the computer program is executed by the processor, includes: obtaining the audio effect audio corresponding to the label of the audio effect audio labeled on the audio effect interval in response to that the original audio is played to the audio effect interval, and playing the audio effect audio.

In an embodiment, the identifying the rhythm point in the original audio, which is implemented when the processor executes the computer program, includes: identifying a beat attribute of the original audio to obtain a beat point of the original audio; analysing a frequency spectrum of the original audio to obtain a feature point in the frequency spectrum of the original audio; matching the original beat point with the feature point in the frequency spectrum of the original audio to obtain the rhythm point of the original audio.

In an embodiment, after creating the label file, which is implemented when the processor executes the computer program, the method further includes: obtaining a preset encryption algorithm, encrypting the label file via the preset encryption algorithm; after obtaining the original audio and the label file corresponding to the original audio, which is implemented when the processor executes the computer program, the method further includes: decrypting the encrypted label file according to a decryption algorithm corresponding to the preset encryption algorithm.

In an embodiment, after creating the label file, which is implemented when the processor executes the computer program, the method further includes: playing the original audio, and traversing the label file according to the playing progress of the original audio; if a modification instruction to the label file is received, modifying the label file according to the modification instruction.

In an embodiment, a computer readable storage medium storing a computer program is provided. The computer program, when executed by the processor, implements the following steps: obtaining an original audio and a label file corresponding to the original audio, the label file including an audio effect audio and an audio effect interval, the audio effect audio including an audio effect to be added in the original audio; playing the original audio, and traversing the label file according to a playing progress of the original audio; playing the audio effect audio in response to that the original audio is played to the audio effect interval of the label file.

In an embodiment, the method for creating the label file, which is implemented when the computer program is executed by the processor, includes: obtaining the original audio; identifying a rhythm point in the original audio, and obtaining an audio effect interval according to a position of the rhythm point in the original audio; obtaining an audio effect audio corresponding to the rhythm point, and establishing a correspondence relationship between the audio effect audio and the audio effect interval; creating the label file according to the audio effect interval and the audio effect audio corresponding to the audio effect interval.

In an embodiment, the obtaining the audio effect audio corresponding to the rhythm point, and establishing the correspondence relationship between the audio effect audio and the audio effect interval, which is implemented when the computer program is executed by the processor, includes: obtaining a label of the audio effect audio corresponding to the rhythm point, labeling the label of the audio effect audio on the audio effect interval; and the playing the audio effect audio in response to that the original audio is played to the audio effect interval of the label file, which is implemented when the computer program is executed by the processor, includes: obtaining the audio effect audio corresponding to the label of the audio effect audio labeled on the audio effect interval in response to that the original audio is played to the audio effect interval, playing the audio effect audio.

In an embodiment, the identifying the rhythm point in the original audio, which is implemented when the computer program is implemented by the processor, includes: identifying a beat attribute of the original audio to obtain a beat point of the original audio; analysing a frequency spectrum of the original audio to obtain a feature point in the frequency spectrum of the original audio; matching the original beat point with the feature point in the frequency spectrum of the original audio to obtain the rhythm point of the original audio.

In an embodiment, after creating the label file, which is implemented when the computer program is executed by the processor, the method further includes: obtaining a preset encryption algorithm, encrypting the label file via the preset encryption algorithm; after obtaining the original audio and the label file corresponding to the original audio, which is implemented when the computer program is executed by the processor, the method further includes: decrypting the encrypted label file according to a decryption algorithm corresponding to the preset encryption algorithm.

In an embodiment, after creating the label file, which is implemented when the computer program is executed by the processor, the method further includes: playing the original audio, and traversing the label file according to the playing progress of the original audio; if a modification instruction to the label file is received, modifying the label file according to the modification instruction.

A person skilled in the art should understand that the processes of the methods in the above embodiments could be, in full or in part, implemented by computer-readable instructions instructing underlying hardware. The computer-readable instructions can be stored in a computer-readable storage medium and executed by at least one processor in the computer operating system. The computer-readable instructions can include the processes in the embodiments of the various methods when it is being executed. Any references to memory, storage, databases, or other media used in various embodiments provided herein may include non-transitory and/or transitory computer-readable storage medium. Non-transitory computer-readable storage medium can include read only memory (ROM), programmable ROM (PROM), electrically programmable ROM (EPROM), electrically erasable programmable ROM (EEPROM), or flash memory. Transitory computer-readable storage medium may include random access memory (RAM) or external high-speed cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), synchronization chain Synchlink DRAM (SLDRAM), memory Bus (Rambus) direct RAM (RDRAM), direct memory bus dynamic RAM (DRDRAM), and memory bus dynamic RAM (RDRAM).

All technical features in the embodiments can be employed in arbitrary combinations. For purpose of simplifying the description, not all arbitrary combinations of the technical features in the embodiments illustrated above are described. However, as long as such combinations of the technical features are not contradictory, they should be considered as within the scope of the disclosure in the specification.

The above embodiments are merely illustrative of several implementations of the disclosure, and the description thereof is more specific and detailed, but should not be construed as limitations to the scope of the present disclosure. It should be noted that variations and improvements will become apparent to those skilled in the art to which the present disclosure pertains without departing from its scope. Therefore, the scope of the present disclosure is defined by the appended claims.

1. An audio playing method, comprising:
obtaining an original audio and a label file corresponding to the original audio, the label file including an audio effect audio and an audio effect interval, the audio effect audio including an audio effect to be added into the original audio, wherein the audio effect audio is an audio file containing content of the audio effect added into the original audio;
playing the original audio and traversing the label file according to a playing progress of the original audio; and
playing the audio effect audio in response to that the original audio is played to the audio effect interval.

2. The method of claim 1, wherein the step of obtaining an original audio and a label file corresponding to the original audio includes:
identifying a rhythm point in the original audio, and obtaining the audio effect interval according to a position of the rhythm point in the original audio;
obtaining the audio effect audio corresponding to the rhythm point, and establishing a correspondence relationship between the audio effect audio and the audio effect interval; and
generating the label file according to the audio effect interval and the audio effect audio corresponding to the audio effect interval.

3. The method of claim 2, wherein the step of obtaining the audio effect audio corresponding to the rhythm point, and establishing a correspondence relationship between the audio effect audio and the audio effect interval, includes:
obtaining a label of the audio effect audio corresponding to the rhythm point, labeling the label of the audio effect audio on the audio effect interval; and
wherein the step of playing the audio effect audio in response to that the original audio is played to the audio effect interval includes:
obtaining the audio effect audio corresponding to the label of the audio effect audio labeled on the audio effect interval in response to that the original audio is played to the audio effect interval, and playing the audio effect audio.

4. The method of claim 2, wherein the step of identifying a rhythm point in the original audio includes:
identifying a beat attribute of the original audio to obtain a beat point of the original audio;
analysing a frequency spectrum of the original audio to obtain a feature point in the frequency spectrum; and
matching the beat point with the feature point to obtain the rhythm point.

5. The method of claim 2, wherein after the step of generating the label file, the method further comprises:
encrypting the label file with a preset encryption algorithm;
wherein after the step of obtaining an original audio and a label file corresponding to the original audio, the method further comprises:
decrypting the encrypted label file according to a decryption algorithm corresponding to the preset encryption algorithm.

6. The method of claim 2, wherein after the step of generating the label file, the method further comprises:
playing the original audio and traversing the label file according to the playing progress of the original audio;
receiving a modification instruction; and
modifying the label file according to the modification instruction.

7. A computer apparatus, comprising:
one or more processors, and
a memory storing computer-readable instructions, which, when executed by the one or more processors cause the one or more processors to perform steps comprising:
obtaining an original audio and a label file corresponding to the original audio, the label file comprising an audio effect audio and an audio effect interval, the audio effect audio comprising an audio effect to be added into the original audio, wherein the audio effect audio is an audio file containing content of the audio effect added into the original audio;
playing the original audio and traversing the label file according to a playing progress of the original audio; and
playing the audio effect audio in response to that the original audio is played to the audio effect interval.

8. The computer apparatus of claim 7, wherein the step of obtaining an original audio and a label file corresponding to the original audio comprises:
identifying a rhythm point in the original audio, obtaining the audio effect interval according to a position of the rhythm point in the original audio;
obtaining the audio effect audio corresponding to the rhythm point, and establishing a correspondence relationship between the audio effect audio and the audio effect interval; and
generating the label file according to the audio effect interval and the audio effect audio corresponding to the audio effect interval.

9. The computer apparatus of claim 8, wherein the step of obtaining the audio effect audio corresponding to the rhythm point, and establishing the correspondence relationship between the audio effect audio and the audio effect interval, comprises:
obtaining a label of the audio effect audio corresponding to the rhythm point, and labeling the label of the audio effect audio on the audio effect interval;
wherein the step of playing the audio effect audio in response to that the original audio is played to the audio effect interval comprises:
obtaining the audio effect audio corresponding to the label of the audio effect audio labeled on the audio effect interval in response to that the original audio is played to the audio effect interval, and playing the audio effect audio.

10. The computer apparatus of claim 8, wherein the step of identifying a rhythm point in the original audio, comprises:
identifying a beat attribute of the original audio to obtain a beat point of the original audio;
analysing a frequency spectrum of the original audio to obtain a feature point in the frequency spectrum; and
matching the beat point with the feature point to obtain the rhythm point.

11. The computer apparatus of claim 8, wherein after the step of generating the label file, the steps further comprise:
encrypting the label file with a preset encryption algorithm;
wherein after the step obtaining an original audio and a label file corresponding to the original audio, the steps further comprise:
decrypting the encrypted label file according to a decryption algorithm corresponding to the preset encryption algorithm.

12. The computer apparatus of claim 8, wherein after the step of generating the label file, the steps further comprise:
playing the original audio, and traversing the label file according to the playing progress of the original audio;
receiving a modification instruction; and
modifying the label file according to the modification instruction.

13. At least one non-transitory computer-readable storage medium comprising computer-readable instructions, which, when executed by one or more processors, cause the one or more processors to perform steps comprising:
obtaining an original audio and a label file corresponding to the original audio, the label file comprising an audio effect audio and an audio effect interval, the audio effect audio comprising an audio effect to be added into the original audio, wherein the audio effect audio is an audio file containing content of the audio effect added into the original audio;
playing the original audio, and traversing the label file according to a playing progress of the original audio; and
playing the audio effect audio in response to that the original audio is played to the audio effect interval.

14. The storage medium of claim 13, wherein the step of obtaining an original audio and a label file corresponding to the original audio comprises:
identifying a rhythm point in the original audio, and obtaining the audio effect interval according to a position of the rhythm point in the original audio;
obtaining the audio effect audio corresponding to the rhythm point, and establishing a correspondence relationship between the audio effect audio and the audio effect interval; and
generating the label file according to the audio effect interval and the audio effect audio corresponding to the audio effect interval.

15. The storage medium of claim 14, wherein the step of obtaining the audio effect audio corresponding to the rhythm point, and establishing the correspondence relationship between the audio effect audio and the audio effect interval, comprises:
obtaining a label of the audio effect audio corresponding to the rhythm point, and labeling the label of the audio effect audio on the audio effect interval;
wherein the step of playing the audio effect audio in response to that the original audio is played to the audio effect interval comprises:
obtaining the audio effect audio corresponding to the label of the audio effect audio labeled on the audio effect interval in response to that the original audio is played to the audio effect interval, and playing the audio effect audio.

16. The storage medium of claim 14, wherein the step of identifying a rhythm point in the original audio, comprises:
identifying a beat attribute of the original audio to obtain a beat point of the original audio;
analysing a frequency spectrum of the original audio to obtain a feature point in the frequency spectrum; and
matching the beat point with the feature point to obtain the rhythm point.

17. The storage medium of claim 14, wherein after the step of generating the label file, the steps further comprise:
encrypting the label file with a preset encryption algorithm;
wherein after the step of obtaining an original audio and a label file corresponding to the original audio, the steps further comprise:
decrypting the encrypted label file according to a decryption algorithm corresponding to the preset encryption algorithm.

18. The storage medium of claim 14, wherein after the step of generating the label file, the steps further comprise:
playing the original audio, and traversing the label file according to the playing progress of the original audio;
receiving a modification instruction; and
modifying the label file according to the modification instruction.
